(19) United States
(12) Patent Application Publication
(10) Pub. No.: US 2006/0143281 A1
(43) Pub. Date: Jun. 29, 2006

(54) Data acquisition source management method and system

(75) Inventor: Yi Li, Singapore (SG)

Correspondence Address: CONLEY ROSE, P.C., P. O. BOX 3267, HOUSTON, TX, 77253-3267, US

(73) Assignee: Wireless Intellect Labs Pte Ltd, Singapore (SG)

(21) Appl. No.: 10/531,942

(22) PCT Filed: Sep. 12, 2003
(86) PCT No.: PCT/SG03/00217

§ 371 Date: Apr. 19, 2005

(30) Foreign Application Priority Data
Oct. 21, 2002 (SG) 200206389-9

(51) Int. Cl. G06F 15/16

(52) U.S. Cl. 709/217

(57) ABSTRACT

A data acquisition source management system for providing centralized management of multimedia acquisition sources and distribution of multimedia data acquired in real-time from the sources over various channels and bearers including cellular Multimedia Messaging Service (MMS) and the Internet is disclosed according to an embodiment of the invention. The data acquisition source management system and 10 method for implementing thereof, allows multimedia acquisition sources, independent of fixed-line or wireless connectivity to the Internet or an Internet protocols-enabled network, to register with a server as an acquisition source. This enables the server to monitor the acquisition source's availability with minimal setup and configuration. The server will distribute a list of available acquisition sources to users for the users to be able to request for real-time data to be captured by the acquisition sources for the data to be transmitted to the user, thereby facilitating optimal utilization of bandwidth.

### FIELD OF INVENTION

The invention relates to a data acquisition source management method. Specifically, the invention relates to a data acquisition source management method for implementing a data acquisition source management system for providing centralized management of multimedia data acquisition sources and distribution of the multimedia data captured in real-time from the acquisition sources over various channels and bearers including cellular MMS (Multimedia Messaging Service) and the Internet is disclosed.

### BACKGROUND

Real-time multimedia data on demand systems, such as Internet-based real-time multimedia data on demand systems, are basically image or audio acquisition sources that are connected to a computer that is connected directly via an Internet connection to a server with the server having capabilities to distribute the multimedia data acquired by the acquisition source over the Internet.

Conventionally, distribution of acquired multimedia data from the acquisition source in the real-time multimedia data on demand systems is accomplished with a permanent FTP (File Transfer Protocol) or the like dedicated connection to a server. The acquisition source continuously transmits acquired data via the FTP connection for storage on a server. When a request for data is received, the data stored on the server is distributed to the source of the request.

One drawback of the abovementioned method is that it requires intensive bandwidth utilization as the acquisition sources are continuously sending data to the server to be stored. Furthermore, there is no guarantee that the data retrieved by a request is in real-time as the status of the acquisition source is not continuously monitored. Special software is also required in the setup used by conventional systems for the acquisition source to retrieve and transmit data. Furthermore, the implementation of such systems are often complex, and technical knowledge and proficiency in networking protocol are requirements as setup of the connection to the server can be complicated, and often beyond the capabilities and/or knowledge and/or patience of the average Internet user.

Hence, this clearly affirms a need for a data acquisition source management method and system for addressing the foregoing disadvantages of conventional real-time multimedia data on demand systems.

### SUMMARY

The present invention is directed to a system and method for the centralized management of data acquisition sources and the distribution of acquired real-time multimedia data. In an embodiment of the invention, a method is provided using a client server model for multiple acquisition sources to function independently under the control of a central server.

The invention relates to a data acquisition source management method. Specifically, the invention relates to a data acquisition source management method for implementing a data acquisition source management system for providing centralized management of multimedia data acquisition sources and distribution of the multimedia data captured in real-time from the acquisition sources over various channels and bearers including cellular MMS (Multimedia Messaging Service) and the Internet is disclosed. Data acquisition sources, independent of having fixed-line or wireless connectivity to the Internet or an alternative Internet protocols-enabled network, are registered with a central server for the server to monitor the status of the acquisition sources with minimal setup and configuration and to further allow request for real-time data directly from any registered acquisition sources with significantly reduced utilization of available bandwidth.

Therefore, in accordance with a first aspect of the invention, there is disclosed a data acquisition source management method for managing acquisition sources, the data acquisition source management method comprising the steps of:
generating a source list for containing at least one acquisition source by a Real-time Multimedia Data On Demand (RTMDOD) server, each of the at least one acquisition source contained in the source list being for provision of data therefrom and being in data communication with the RTMDOD server;
providing the source list to a data requestor system, the source list being provided by the RTMDOD server in response to the RTMDOD server receiving a list request from the data requestor system, the data requestor system being in data communication with the RTMDOD server; and
receiving a data request from the data requestor system by the RTMDOD server, the data request being a request for data from one or more of the at least one acquisition source being registered on the source list and being indicated thereby.

In accordance with a second aspect of the invention, there is disclosed a data acquisition source management system for managing acquisition sources, the data acquisition source management system comprising:
the means for generating a source list for containing at least one acquisition source by a Real-time Multimedia Data On Demand (RTMDOD) server, each of the at least one acquisition source contained in the source list being for provision of data therefrom and being in data communication with the RTMDOD server;
the means for providing the source list to a data requestor system, the source list being provided by the RTMDOD server in response to the RTMDOD server receiving a list request from the data requestor system, the data requestor system being in data communication with the RTMDOD server; and
the means for receiving a data request from the data requestor system by the RTMDOD server, the data request being a request for data from one or more of the at least one acquisition source being registered on the source list and being indicated thereby.

### BRIEF DESCRIPTION OF THE DRAWINGS

Embodiments of the invention are described hereinafter with reference to the following drawings, in which:

FIG. 1 shows a process flow diagram of a data acquisition source management method according to an embodiment of the invention;

FIG. 2 shows a first system layout diagram of a data acquisition source management system for implementing the data acquisition source management method of FIG. 1;

FIG. 3 shows a process flow diagram of generating a source list in a step of the data acquisition source management method of FIG. 1;

FIG. 4 shows a process flow diagram of disseminating the source list in a step of the data acquisition source management method of FIG. 1;

FIG. 5 shows a system representation diagram of a Real-time Multimedia Data On Demand (RTMDOD) server of the data acquisition source management system of FIG. 2; and

FIG. 6 shows a second system layout diagram of the acquisition management system of FIG. 2.

### DETAILED DESCRIPTION

A data acquisition source management method for addressing the foregoing problems is described hereinafter.

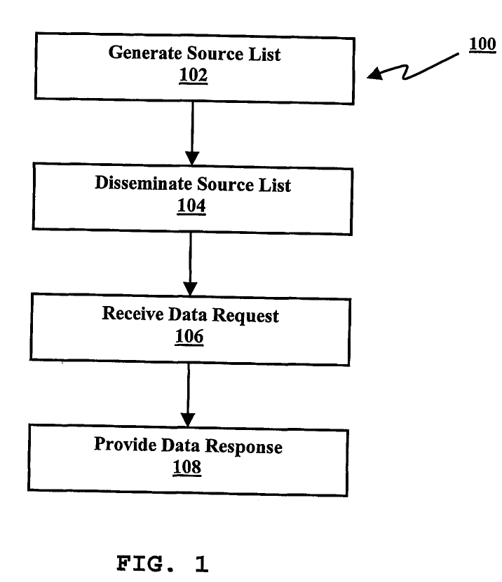

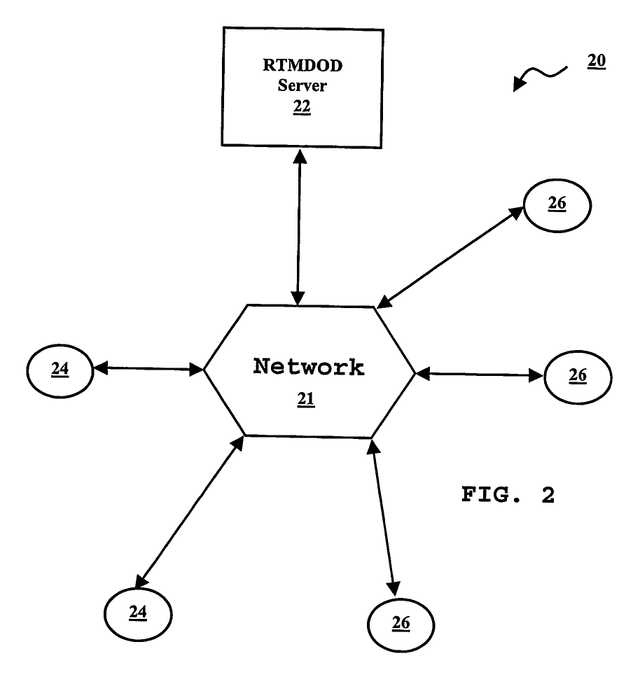

According to an embodiment of the invention, a data acquisition source management system 20, as shown in FIG. 2, for implementing a data acquisition source management method 100 is described with reference to FIG. 1. FIG. 1 shows a process flow diagram of the data acquisition source management method 100, and FIG. 2 shows a first system layout diagram of the data acquisition source management system 20.

With reference to FIG. 2, the data acquisition source management system 20 comprises of a Real-time Multimedia Data On Demand (RTMDOD) server system 22, a plurality of data requestor systems 24 (also known as a data requestor) and a plurality of acquisition sources 26. The RTMDOD, the plurality of data requestor systems 24 and the plurality of acquisition sources 26 are interconnected over a network system 21. The network system 21 may be the Internet, an Intranet, a cellular Multimedia Messaging Service system, or the like communication infrastructures.

The architecture of the RTMDOD system 22 follows the client/server model, where multiple clients function independently under the control of a central server with the data requestors 24 and the acquisition sources 26 being the clients and the RTMDOD system 22 being the central server.

The acquisition sources 26 are wherefrom data originates. Software programs are customized for interfacing the hardware of the acquisition sources 26 and the RTMDOD server 22.

The data acquisition source management method 100 is for managing the acquisition sources 26. In the data acquisition source management method 100, the RTMDOD server 22 generates a source list (not shown) containing the quantity of acquisition sources available 26 in a step 102 as shown in FIG. 1. The quantity of acquisition sources available can be zero, one or more. The acquisition sources 26 contained in the source list are for provision of data therefrom. The acquisition sources 26 are in data communication with the RTMDOD server 22.

The source list is then provided to a data requestor 24 in a step 104, in response to the RTMDOD server receiving a list request from the data requestor 24. The data requestor 24 is in data communication with the RTMDOD server 22. Once the source list has been disseminated to the data requestor 24, the RTMDOD server 22 is able to receive a data request from the data requestor 24 in a step 106 of FIG. 1. The data request (not shown) is a request for data from one or more acquisition sources available 26 that has been registered on the source list.

In response to the data request being received by the RTMDOD server 22 in the step 106, the RTMDOD server 22 proceeds to provide a data response to the data requestor 24 in a step 108 as explained hereinafter. The data request may be initiated independently by the data requester 24 or may be initiated by an external stimulus, for example, a mobile phone generated SMS from a user, the receipt of an email from a user or the like event-based activations.

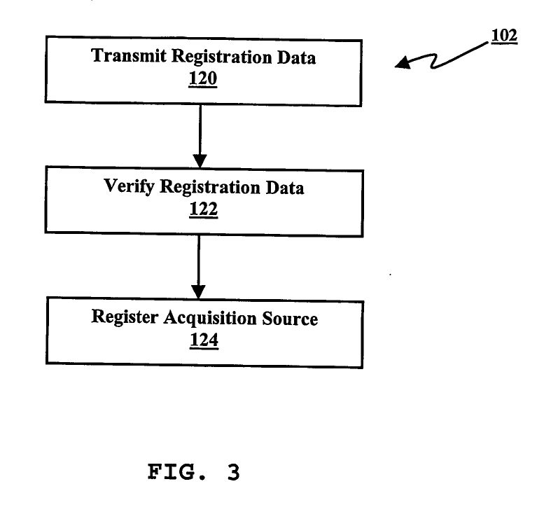

In the step 102, the source list is generated and updated when one or more acquisition sources register with the RTMDOD server 22. Registration is initiated upon starting-up of each acquisition source 26. In the step 102, registration data (not shown) is transmitted from the acquisition source 26 to the RTMDOD server 22 in a step 120 of FIG. 3, which shows a process flow diagram of generating a source list. The registration data is then verified by the RTMDOD server in a step 122 of FIG. 3. Once the registration data has been verified in the step 122, the acquisition source 26 is finally registered onto the source list, in a step 124, with the registration data corresponding to the acquisition source 26 being stored onto a source database (not shown).

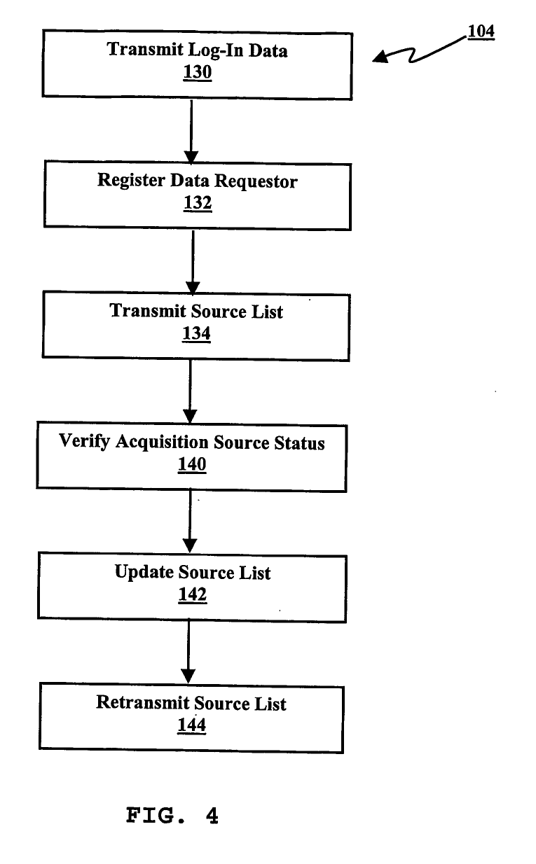

FIG. 4 shows a process flow diagram of disseminating the source list in the step 104 of FIG. 1. In the step 104, log-in data is first transmitted from the data requestor 24 to the RTMDOD server 22 in a step 130 of FIG. 4. With reference to FIG. 4, the log-in data is provided for logging the data requestor 24 into the RTMDOD server 22. In response to the log-in data being received in the step 130, the data requestor is registered onto a requestor list (not shown) in a step 132. The requestor list contains at least one data requestor 24. Once the data requestor has been registered or logged onto the RTMDOD server 22, the source list is transmitted from the RTMDOD server 22 to the corresponding data requestor 24 in a step 134.

However, one or more of the acquisition source 26 may be deactivated after a period of time. Therefore, the status of each acquisition source 26 in the source list has to be constantly checked. The status of each acquisition source 26 is one of active or inactive. Further in the step 104, the status of each of the acquisition source 26 is verified periodically in a step 140. Alternatively, the status of each of the acquisition sources 26 is further verified by requiring that the corresponding acquisition source 26 periodically send a status signal to the RTMDOD server 22.

The periodic verification step, as aforementioned, is akin to a heartbeat for pulsing status request signals from the RTMDOD server 22 to the acquisition source 26 or vice versa (not shown). If a status signaling is used and in such a case if a status signal is not received from the acquisition source 26 within a predetermined time interval, the status of the corresponding acquisition source 26 is updated as being inactive and the corresponding acquisition source 26 is then removed from the source list in a step 142, thereby updating the source list. Upon updating of the source list in the step 142, the source list is retransmitted to all the data requester 24 that are logged onto the RTMDOD server 22, and registered on the requester list, in a step 144. The status verification of the acquisition source 26 is preferred in situations where a dynamically assigned IP is used by the acquisition source 26.

Following the data request from the data requestor 24 in the step 106, the RTMDOD server 22 proceeds to prepare and transmit a data response as aforementioned in the step 108 of FIG. 1. In the step 108, the data requested is transmitted from the RTMDOD server 22 to the data requestor 24. But before this takes place, a request is sent to the corresponding acquisition source 26 to acquire the data (not shown). The data received by the RTMDOD server 22 from the corresponding acquisition source 26 is then transmitted to the data requestor 24 in real-time, with the data being multimedia data. Alternatively, an error message is sent as the data response when an error occurs before or during transmission of the data.

The handling of the data request and data response by the RTMDOD server 22 is preferably serialized. Once one data request has been sent, the RTMDOD server 22 will not try to send another data request before a data response is received for the previous data request. This is to prevent the RTMDOD server 22 from overloading the acquisition source 26 which may have limited networking and computing capabilities.

However, the RTMDOD server 22 is capable of serving multiple data requests from the data requestors 24 to multiple acquisition sources 26 simultaneously.

Once the data corresponding to the data request has been completely received by the data requestor 24, the data requestor 24 can proceed to log-out from the RTMDOD server 22. Once a log-out instruction has been received from the data requestor 24, the RTMDOD server 22 proceeds to remove the corresponding data requestor 24 from the requester list. This reduces the quantity of data requestor 24 that has to be updated by the RTMDOD server 22 whenever the source list is updated.

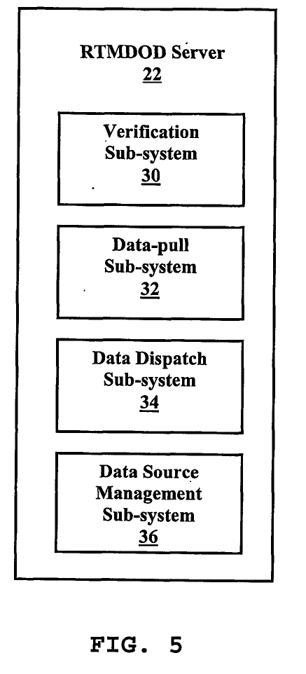

Preferably, the RTMDOD server 22 comprises of four sub-systems: a verification sub-system 30, the data-pull sub-system 32, the data dispatch sub-system 34 and the data source management sub-system 36. The four sub-systems are shown in FIG. 5, which shows a system representation diagram of the RTMDOD server 22. The verification sub-system 30 is for verifying and updating the status of the acquisition source 26 contained in the source list. The data-pull sub-system 32 is for managing the retrieval of data from the acquisition source 26 upon receiving the data request from the data requestor 24. The data dispatch sub-system 34 is for managing communications with and data transmission to the data requestor 24. The data source management system 36 is for managing and updating the source list and the requestor list.

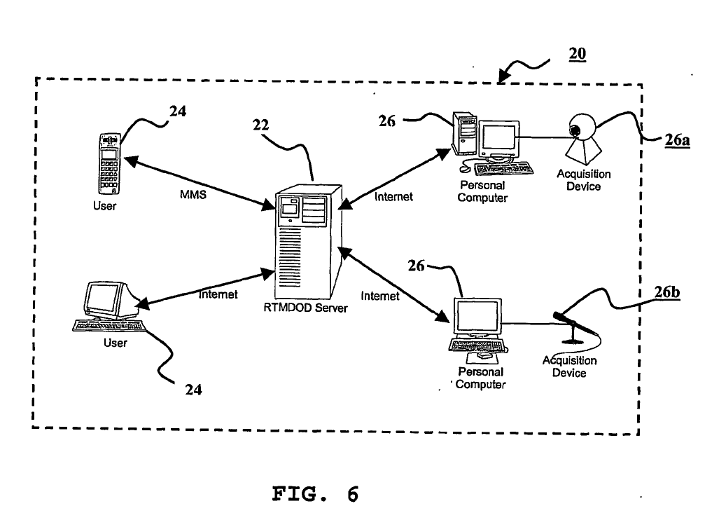

The data acquisition source management system 20 improves upon current real-time multimedia data on demand systems as it enables the acquisition source 26, for example video 26a, audio 26b (as shown in FIG. 6) or any other media types, to connect and register with the RTMDOD server 22 regardless of connection type and the presence of security devices like firewalls. Preferably, the acquisition source 26 uses only existing device drivers, for example a digital camera using its TWAIN driver instead of requiring special acquisition software, thereby making the data acquisition source management system 20 device independent and significantly reducing installation and configuration complexity.

Compared to conventional systems, only minimal bandwidth is required as the data acquisition source management method 100 does not require the acquisition sources to continuously transmit data to the RTMDOD server 22 for storage therein. Request and transmission of data will only occur when a request is made from a data requestor, thereby substantially reducing bandwidth usage.

In the foregoing manner, a data acquisition source management method for implementing a data acquisition source management system is described according to an embodiment of the invention for addressing the foregoing disadvantages of conventional acquisition source management system. It will be apparent to one skilled in the art in view of this disclosure that numerous changes and/or modification can be made without departing from the scope and spirit of the invention.

1. A data acquisition source management method for managing acquisition sources, the data acquisition source management method comprising the steps of:
generating a source list for containing at least one acquisition source by a Real-time Multimedia Data On Demand (RTMDOD) server, each of the at least one acquisition source contained in the source list being for provision of data therefrom and being in data communication with the RTMDOD server;
providing the source list to a data requestor system, the source list being provided by the RTMDOD server in response to the RTMDOD server receiving a list request from the data requestor system, the data requestor system being in data communication with the RTMDOD server; and
receiving a data request from the data requestor system by the RTMDOD server, the data request being a request for data from one or more of the at least one acquisition source being registered on the source list and being indicated thereby.

2. The data acquisition source management method as in claim 1, further comprising a step of:
providing a data response from the RTMDOD server to the data requestor system in responses to the data request being received by the RTMDOD server from the data requestor system.

3. The data acquisition source management method as in claim 1, the step of generating a source list containing at least one acquisition source comprising the steps of:
transmitting registration data from the at least one acquisition source to the RTMDOD server;
verifying the registration data from the at least one acquisition source by the RTMDOD server; and
registering the at least one acquisition source onto the source list and storing the registration data corresponding to the registered at least one acquisition source onto a source database in response to the registration data being verified.

4. The data acquisition source management method as in claim 1, the step of providing a source list to the data requestor system comprising the steps of:
transmitting log-in data from the data requestor system to the RTMDOD server;
registering the data requestor system onto a requestor list in response to receiving the log-in data therefrom, the requestor list containing at least one of a plurality of data requester systems; and
transmitting the source list to each of the plurality of data requestor system registered on the requestor list.

5. The data acquisition source management method as in claim 2, the step of providing a data response from the RTMDOD server to the data requestor system comprising a step of:
transmitting data from the RTMDOD server to the data requestor system, the data being provided by one or more of the at least one acquisition source indicated by and in response to the data request.

6. The data acquisition source management method as in claim 5, wherein the data transmitted from the corresponding at least one acquisition source to the RTMDOD server is subsequently received by the data requestor system in real-time therefrom.

7. The data acquisition source management method as in claim 5, the data received by the RTMDOD server from the corresponding at least one acquisition source being multimedia data.

8. The data acquisition source management method as in claim 2, further comprising a step of:
providing an error message to the data requestor system by the RTMDOD server in response to the data request.

9. The data acquisition source management method as in claim 4, the step of providing a source list to the data requestor system further comprising the steps of:
verifying status of each of the acquisition source registered on the source list, the status of each of the acquisition source being one of active or inactive;
updating the source list by removing the acquisition source having the status of inactive therefrom; and
transmitting the updated source list to each of the plurality of data requestor system registered on the requestor list.

10. A data acquisition source management system for managing acquisition sources, the data acquisition source management system comprising:
the means for generating a source list for containing at least one acquisition source by a Real-time Multimedia Data On Demand (RTMDOD) server, each of the at least one acquisition source contained in the source list being for provision of data therefrom and being in data communication with the RTMDOD server;
the means for providing the source list to a data requestor system, the source list being provided by the RTMDOD server in response to the RTMDOD server receiving a list request from the data requestor system, the data requestor system being in data communication with the RTMDOD server; and
the means for receiving a data request from the data requestor system by the RTMDOD server, the data request being a request for data from one or more of the at least one acquisition source being registered on the source list and being indicated thereby.

11. The data acquisition source management system as in claim 10, further comprising:
the means for providing a data response from the RTMDOD server to the data requestor system in responses to the data request being received by the RTMDOD server from the data requester system.

12. The data acquisition source management system as in claim 10, wherein the means for generating a source list containing at least one acquisition source comprising:
the means for transmitting registration data from the at least one acquisition source to the RTMDOD server;
the means for verifying the registration data from the at least one acquisition source by the RTMDOD server; and
the means for registering the at least one acquisition source onto the source list and storing the registration data corresponding to the registered at least one acquisition source onto a source database in response to the registration data being verified.

13. The data acquisition source management system as in claim 10, wherein the means for providing a source list to the data requestor system comprising:
the means for transmitting log-in data from the data requestor system to the RTMDOD server;
the means for registering the data requestor system onto a requester list in response to receiving the log-in data therefrom, the requester list containing at least one of a plurality of data requestor systems; and
the means for transmitting the source list to each of the plurality of data requestor system registered on the requestor list.

14. The data acquisition source management system as in claim 11, wherein the means for providing a data response from the RTMDOD server to the data requestor system comprising:
the means for transmitting data from the RTMDOD server to the data requestor system, the data being provided by one or more of the at least one acquisition source indicated by and in response to the data request.

15. The data acquisition source management system as in claim 14, wherein the data transmitted from the corresponding at least one acquisition source to the RTMDOD server is subsequently received by the data requestor system in real-time therefrom.

16. The data acquisition source management system as in claim 14, wherein the data received by the RTMDOD server from the corresponding at least one acquisition source being multimedia data.

17. The data acquisition source management system as in claim 11, further comprising:
the means for providing an error message to the data requestor system by the RTMDOD server in response to the data request.

18. The data acquisition source management system as in claim 13, wherein the means for providing a source list to the data requestor system further comprising:
the means for verifying status of each of the acquisition source registered on the source list, the status of each of the acquisition source being one of active or inactive;
the means for updating the source list by removing the acquisition source having the status of inactive therefrom; and
the means for transmitting the updated source list to each of the plurality of data requestor system registered on the requestor list.
